(19) United States
(12) Patent Application Publication
(10) Pub. No.: US 2011/0046962 A1
(43) Pub. Date: Feb. 24, 2011

(54) VOICE TRIGGERING CONTROL DEVICE AND METHOD THEREOF

(75) Inventors: Ting-Lin Chang, Taoyuan County (TW); Ching-Feng Hsieh, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: ASKEY COMPUTER CORP., Taipei (TW)

(21) Appl. No.: 12/560,718

(22) Filed: Sep. 16, 2009

(30) Foreign Application Priority Data
Aug. 18, 2009 (TW) 098127748

(51) Int. Cl. G10L 15/00

(52) U.S. Cl. 704/275; 704/E15.001

(57) ABSTRACT

A voice triggering control device for enabling a data collection host which assembled on it comprises a processing unit, a speaker, a control module, a power supply module and a housing containing the elements disclosed above. The control device controls the processing unit to output a high-frequency audio signal which is corresponded to an act command Then, broadcasting a high-frequency audio through the speaker, wherein the high-frequency audio is generated by the high-frequency audio signal, and the data collection host is enabled to perform the act command while receiving and decoding the high-frequency audio. Thereby, making the triggering control device enabling the data collection host proceed a functional action by the high-frequency audio can solve the contact fault problem in the prior art.

### CROSS-REFERENCE TO RELATED APPLICATIONS

This non-provisional application claims priority under 35 U.S.C. §119(a) on Patent Application No(s).098127748 filed in Taiwan, R.O.C. on 18 Aug. 2009, the entire contents of which are hereby incorporated by reference.

### FIELD OF THE INVENTION

The present invention relates to a triggering control technology, and more particularly to a voice triggering control device and a method of enabling a data collection host through a high audio frequency triggering signal.

### BACKGROUND OF THE INVENTION

Data collection host is a device for retrieving various different data and generally installed with a triggering controller, and a common data collection host includes a barcode reader and a barcode scanner, etc. The barcode reader is a tool for reading a barcode, such as a barcode number 1234, and the barcode reader will receive a digital data representing 1234. In addition, the functions of the barcode scanner and the barcode reader are very similar, and an operating system and a storage medium are usually built in the barcode scanner and reader, such that when data are collected, the data are stored in the storage medium for further calculation and management, and then the data are inputted into a computer for comparison, or transferred from the data collection host to other devices, and thus such data collection host is very suitable for inventory count, asset count or shipping procedure.

A handheld triggering controller of the conventional data collection host is connected directly to a machine interface for triggering the data collection host to execute a data collection. In general, an opening is designed on the triggering controller and a main body of the data collection host for installing a link mechanism (such as a communication line), such that the triggering controller can enable the data collection host through the link mechanism to execute different data collection functions during an operation. After a long time of use adopting the aforementioned operating method, the link mechanism may be damaged easily, and a fault trigger may occur.

To overcome the foregoing shortcomings, a conventional infrared communication method is used for triggering the data collection host directly, or a conventional magnetic sensing method is used for triggering the data collection host to enable a function.

Since the data collection host of the triggering controller is plugged, unplugged or replaced frequently due to different occasions or different functional requirements, a transparent window used in the infrared communication for receiving infrared rays will be worn out or damaged easily when the triggering controller is plugged and unplugged with the data collection host frequently, and thus a low penetration rate is resulted to cause a fault trigger or a poor triggering effect.

Another conventional magnetic sensing method is used for the triggering function. Although such method can avoid the issues created by the infrared communication method and the poor contact of the communication line, yet the magnetic sensing method is affected by the using environment easily to cause a sensing failure of the data collection host or a wrong execution by the data collection host, and it is a subject of the present invention to disclose a way of overcoming the aforementioned shortcomings of the conventional voice triggering control device and data collection host.

### SUMMARY OF THE INVENTION

Therefore, it is a primary objective of the present invention to provide a voice triggering control device and a method of the present invention to prevent a failure of triggering due to a poor contact or an environmental influence.

Another objective of the present invention is to provide a voice triggering control device that provides a better waterproof and dustproof effect.

To achieve the foregoing objectives, the present invention provides a voice triggering control device for enabling a data collection host connected to the voice triggering control device to execute a corresponding functional action, and the voice triggering control device comprises: a processing unit, for outputting a high-frequency audio signal corresponding to the functional action; a speaker, electrically coupled to the processing unit, for playing a high-frequency audio according to the high-frequency audio signal to enable the data collection host to execute the functional action; a control module, electrically coupled to the processing unit, for controlling an output of the high-frequency audio signal; a power supply module, electrically coupled to the processing unit and the speaker, for supplying required electric power; and a housing, for accommodating the processing unit, the speaker, the control module and the power supply module, and including a connection portion for connecting the data collection host.

In the aforementioned voice triggering control device, the high-frequency audio signal has a frequency ranging from 15000 Hz to 20000 Hz. In addition, the housing of the embodiment includes a holding structure provided for facilitating a user's grip. The control module further includes a press-button switch provided for outputting a start signal to control the high-frequency audio signal.

In the aforementioned voice triggering control device, the functional action is a scanning action or an image capturing action.

To achieve the foregoing objectives, the present invention also provides a voice triggering control method, comprising the steps of: (a) using a control module of the voice triggering control device to control a processing unit, such that the processing unit outputs a high-frequency audio signal corresponding to the functional action; (b) using a speaker of the voice triggering control device to play a high-frequency audio according to the high-frequency audio signal; and (c) letting the data collection host receive and decode the high-frequency audio to enable the data collection host to execute the functional action.

In the foregoing voice triggering control method, the processing unit outputs the high-frequency audio signal ranging from 15000 Hz to 20000 Hz. In Step (a), the processing unit decodes an instruction according to the functional action to generate the high-frequency audio signal. In Step (c), the data collection host receives the high-frequency audio and decodes an instruction to enable the data collection host to execute the functional action, wherein the functional action is a scanning action or an image capturing action. Unlike the prior art, bodies of the voice triggering control device and the data collection host in accordance with the present invention do not require any additional opening for installing the communication line to provide a better waterproof and dustproof effect. In addition, the wireless triggering method adopting an audio triggering can provide a stable operation for the data collection host without the poor contact issue, and the high audio frequency signal will not be interfered by the using environment easily, and thus the present invention can reduce the possibility of a wrong triggering.

### BRIEF DESCRIPTION OF THE DRAWINGS

FIG. 1 is a functional block diagram of controlling a data collection host in accordance with a preferred embodiment of the present invention;

FIG. 2 is a schematic view of installing a voice triggering control device to a data collection host in accordance with a preferred embodiment of the present invention;

FIG. 3 is a schematic view of a voice triggering control device using a high-frequency audio for a control in accordance with a preferred embodiment of the present invention; and

FIG. 4 is a flow chart of a voice triggering control method in accordance with a preferred embodiment of the present invention.

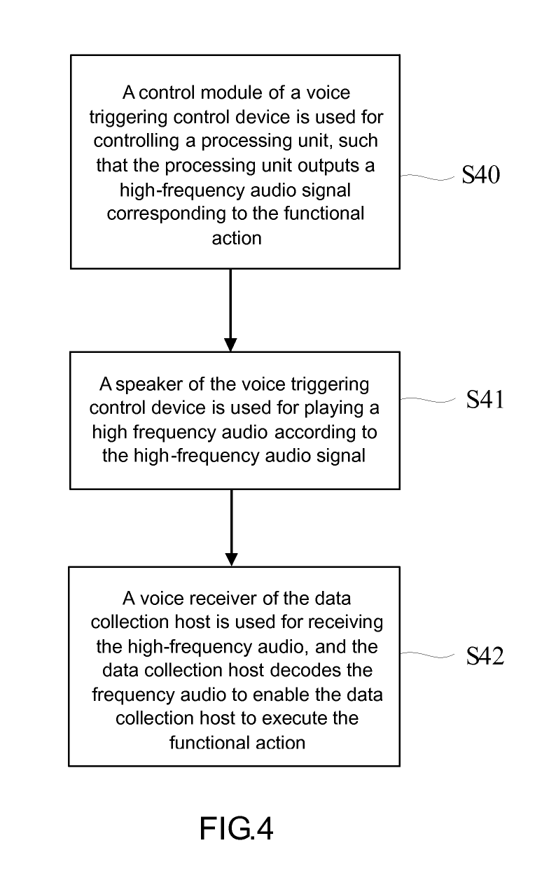

### DESCRIPTION OF THE PREFERRED EMBODIMENT

Other features and advantages of the present invention will become apparent in the following detailed description of the preferred embodiments with reference to the accompanying drawings.

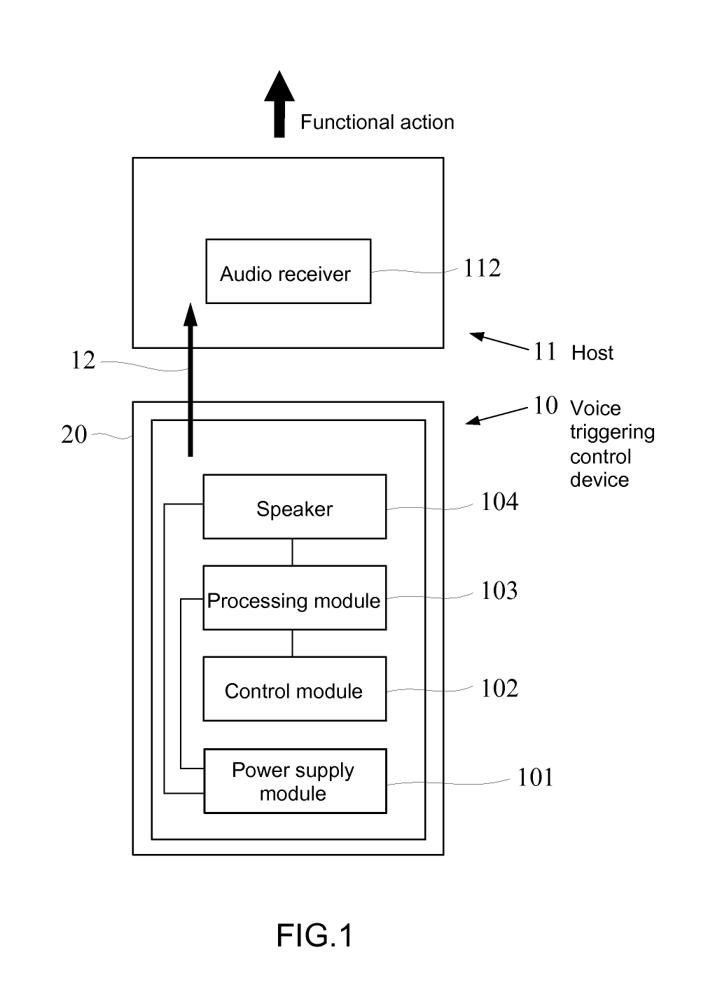

With reference to FIG. 1 for a functional block diagram of controlling a data collection host in accordance with a preferred embodiment of the present invention, the voice triggering control device 10 is used for enabling a data collection host 11 connected to the voice triggering control device 10, such that the data collection host 11 can execute a corresponding functional action, and the voice triggering control device 10 includes a power supply module 101 for supplying required electric power to the voice triggering control device 10.

In FIG. 1, the voice triggering control device 10 of the present invention comprises a processing unit 103, a speaker 104, a control module 102, a power supply module 101 and a housing 20. The processing unit 103 is provided for decoding an instruction corresponding to a functional action to output a high-frequency audio signal, and the speaker 104 is provided for playing a high-frequency audio according to the high-frequency audio signal 12, and then a voice receiver 112 installed in the data collection host 11 receives the audio, and the data collection host 11 decodes an instruction into the functional action to enable the data collection host 11 to execute the functional action. The processing unit 103 can use a micro controller unit (MCU) to perform various functions of the processing unit 103. The housing 20 is provided for accommodating the processing unit 103, the speaker 104, the control module 102 and the power supply module 101.

In a preferred embodiment, the power supply module 101 supplies electric power to the voice triggering control device 10, such that the data collection host 11 can execute the corresponding functional action. If a user sends out an instruction through the control module 102, the processing unit 103 will decode the instruction of the functional action to generate a high-frequency audio signal, and then plays the high-frequency audio through the speaker 104 according to the high-frequency audio signal. To avoid any interference to human ears, the high-frequency audio signal has a frequency over 15 KHz. The voice receiver 112 installed on the data collection host 11 receives the high-frequency audio and outputs the high-frequency audio signal, and the data collection host 11 decodes the high-frequency audio signal into an instruction of the functional action. Finally, the data collection host 11 is enabled to execute the corresponding functional action, wherein the functional action is a scanning action or an image capturing action.

In this preferred embodiment, the high-frequency audio signal has a frequency ranging from 15000 Hz to 20000 Hz, wherein any audio frequency from 15000 Hz to 20000 Hz with an increment of 500 Hz can be used for the present invention.

In this preferred embodiment, a housing 20 of the voice triggering control device 10 includes a holding structure provided for facilitating a user's grip. The invention is not limited to such holding structure only, but any other appropriate equivalent holding structure can be used for the present invention.

The power supply module 101 is a rechargeable battery module to provide the convenience of portability, but an adapter connected to utility power can be used for supplying electric power, or the utility power can be used for charging the rechargeable battery module.

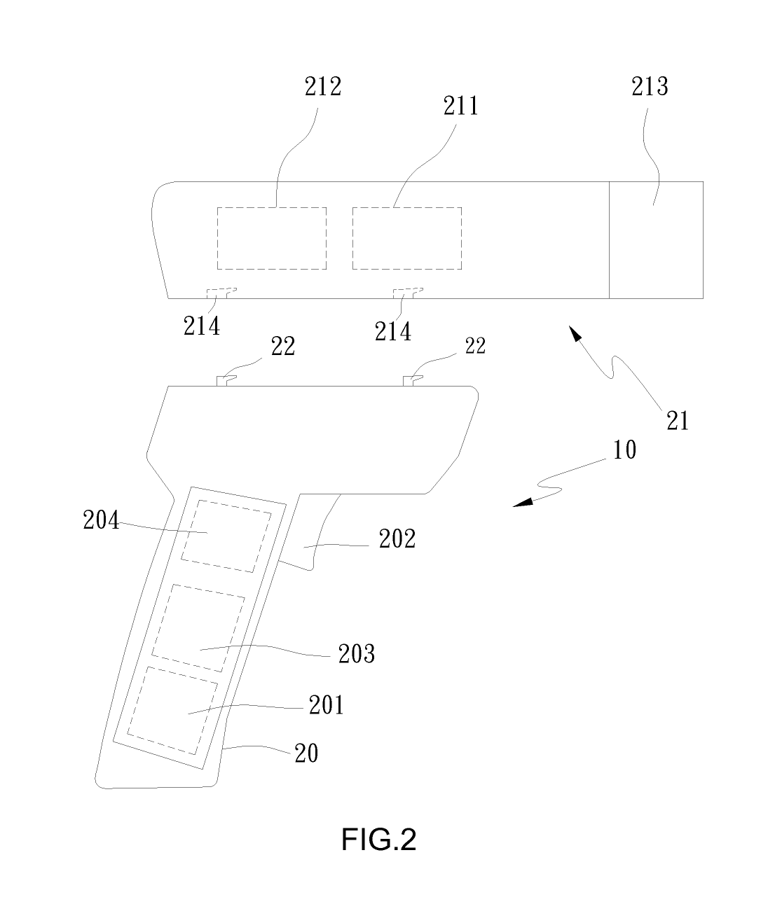

With reference to FIG. 2 for a schematic view of installing a voice triggering control device to a data collection host in accordance with a preferred embodiment of the present invention, the voice triggering control device 10 comprises a processing unit 203, a speaker 204, a control module 202, a power supply module 201 and a housing 20. The housing 20 includes a holding structure connected to a connection portion 214 corresponding to a data collection host 21 through a connection portion 22 or any other connecting method, wherein the connection portion 22 can be a tenon. The housing 20 is provided for accommodating the control module 202, the power supply module 201, the processing unit 203 and the speaker 204. In this preferred embodiment, the control module 201 comprises a press-button switch, and the power supply module 203 is a rechargeable battery module, and the processing unit 203 is a micro controller unit. The data collection host 21 includes a rechargeable battery module 211, a voice receiver 212 and a scanning module 213 for executing a scanning function. Electric power can be supplied to the voice triggering control device 10 having the housing 20 and the data collection host 21 through the rechargeable battery module. Similarly, electric power can be supplied to the voice triggering control device 10 and the data collection host 21 through the utility power.

In an embodiment, a user can press the press-button switch to control a micro controller unit, such that the micro controller unit controls an encoding procedure and encodes a scan action into a high-frequency audio signal with a frequency over 15 Khz, and then the speaker 204 is provided for playing a high-frequency audio according to the high-frequency audio signal. The data collection host 21 receives the high-frequency audio through the built-in voice receiver 212 and outputs the high-frequency audio signal, and the data collection host 21 decodes the high-frequency audio signal into the scanning action, and the scanning action is inputted into the scanning module 213 to execute the corresponding scanning action.

For example, if a user presses a “SCAN” press-button switch, the micro controller unit will start and execute the encoding procedure for a scanning action, and will encode the scanning action into a high-frequency audio signal, and then will play a high-frequency audio through the speaker 204 according to the high-frequency audio signal, and the data collection host 21 will decode the received high-frequency audio signal into the scanning action for executing the corresponding scanning action, and the action of enabling the data collection host 21 is completed. On the other hand, if the user has not pressed the “Scan” press-button switch, the micro controller unit will not start executing the encoding procedure. In other words, the procedure of outputting the high-frequency audio signal is disabled.

In the data collection host 21, the scanning module 213 can be replaced by an image capturing module or a combination of a scanning module and an image capturing module for executing an image capturing action. It is noteworthy to point out that the present invention is not limited to the data scanning action or the image capturing action only, but persons ordinarily skilled in the art can use any other data collection related modules and functional actions in the present invention.

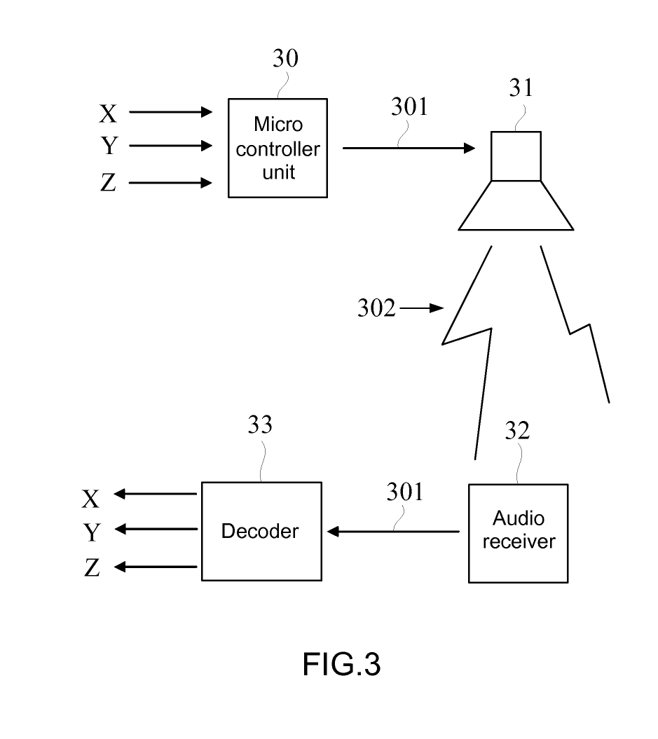

With reference to FIG. 3 for a schematic view of a voice triggering control device using a high-frequency audio for a control in accordance with a preferred embodiment of the present invention, this preferred embodiment adopts a micro controller unit (MCU) 30, a speaker 31, a voice receiver 32 and a decoding unit to implement the wireless triggering control method for the data collection, wherein the micro control unit 30 is equivalent to the aforementioned processing unit 103, 203.

Firstly, an image capturing instruction X, a scanning instruction Y or an instruction of any other functional action, or a combination of the above is inputted into the micro control unit 30, wherein each instruction can be in an analog signal or a digital signal. The micro control unit 30 encodes the inputted instruction into a corresponding high-frequency signal 301 with a frequency over 15 Khz, and the speaker 31 plays a high-frequency audio according to the high-frequency audio signal 301, and then the voice receiver 32 receives and converts the high-frequency audio 302 into the high-frequency audio signal 301 to be inputted into a decoder 33, wherein the decoder 33 is installed in the aforementioned data collection host. Finally, the decoder 33 decodes the high-frequency signal 301 to form a corresponding image capturing instruction X, a scanning instruction Y or any other functional action instruction for executing the corresponding functional action, such that the present invention can achieve the wireless triggering control effect through the high-frequency audio 302.

With reference to FIG. 3 for a flow chart of a voice triggering control method in accordance with the present invention, the voice triggering control method is used for enabling a data collection host to execute a functional action. In Step S40, a control module of a voice triggering control device is used for controlling a processing unit, such that the processing unit outputs a high-frequency audio signal corresponding to the functional action. In Step S41, a speaker of the voice triggering control device is used for playing a high-frequency audio according to the high-frequency audio signal. In Step S42, a voice receiver of the data collection host is used for receiving the high-frequency audio, and the data collection host decodes the frequency audio to enable the data collection host to execute the functional action.

The high-frequency signal has a frequency over 15000 Hz, and preferably ranging from 15000 Hz to 20000 Hz to avoid any interference to human ears.

The present invention adopts the aforementioned voice triggering control device and method, wherein the voice triggering control device transmits a high-frequency audio to trigger the data collection host installed on the voice triggering control device, such that the data collection host is enabled to execute the corresponding functional action. Since there is no opening or link mechanism between the voice triggering control device and the data collection host, therefore the problem of the triggering fault caused by the environmental influence in the prior art can be overcome.

While the invention has been described by means of specific embodiments, numerous modifications and variations could be made thereto by those skilled in the art without departing from the scope and spirit of the invention set forth in the claims.

What is claimed is:

1. A voice triggering control device, used for enabling a data collection host connected to the voice triggering control device to execute a corresponding functional action, and the voice triggering control device comprising:
a processing unit, for outputting a high-frequency audio signal corresponding to the functional action;
a speaker, electrically coupled to the processing unit, for playing a high-frequency audio according to the high-frequency audio signal to enable the data collection host to execute the functional action;
a control module, electrically coupled to the processing unit, for controlling an output of the high-frequency audio signal;
a power supply module, electrically coupled to the processing unit and the speaker, for supplying a required power; and
a housing, for accommodating the processing unit, the speaker, the control module and the power supply module, and having a connection portion for coupling the data collection host.

2. The voice triggering control device of claim 1, wherein the high-frequency audio signal has a frequency ranges from 15000 Hz to 20000 Hz.

3. The voice triggering control device of claim 1, wherein the housing includes a holding structure.

4. The voice triggering control device of claim 1, wherein the control module includes a press-button switch for outputting a start signal to control an output of the high-frequency audio signal.

5. The voice triggering control device of claim 1, wherein the connection portion is a connecting tenon.

6. The voice triggering control device of claim 1, wherein the power supply module is a rechargeable battery module.

7. The voice triggering control device of claim 1, wherein the functional action is a scanning action or an image capturing action.

8. A voice triggering control method, used for enabling a data collection host connected to the voice triggering control device to execute a corresponding functional action, and the voice triggering control method comprising the steps of:
(a) using a control module of the voice triggering control device to control a processing unit, such that the processing unit outputs a high-frequency audio signal corresponding to the functional action;
(b) using a speaker of the voice triggering control device to play a high-frequency audio according to the high-frequency audio signal; and
(c) letting the data collection host receive and decode the high-frequency audio to enable the data collection host to execute the functional action.

9. The voice triggering control method of claim 8, wherein the processing unit in Step (a) outputs the high-frequency audio signal with a frequency ranging from 15000 Hz to 20000 Hz.

10. The voice triggering control method of claim 8, wherein the processing unit in Step (a) decodes an instruction to generate the high-frequency audio signal according to the functional action.

11. The voice triggering control method of claim 8, wherein the data collection host in Step (c) receives the high-frequency audio, and decodes the instruction to enable the data collection host to execute the functional action.

12. The voice triggering control method of claim 8, wherein the functional action is a scanning action or an image capturing action.
